(19) United States
(12) Patent Application Publication
(10) Pub. No.: US 2006/0004965 A1
(43) Pub. Date: Jan. 5, 2006

(54) Direct processor cache access within a system having a coherent multi-processor protocol

(76) Inventors: Steven J. Tu, Phoenix, AZ (US); Samantha J. Edirisooriya, Tempe, AZ (US); Sujat Jamil, Chandler, AZ (US); David E. Miner, Chandler, AZ (US); R. Frank O'Bleness, Tempe, AZ (US); Hang T. Nguyen, Tempe, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/883,363

(22) Filed: Jun. 30, 2004

(51) Int. Cl. G06F 12/00

(52) U.S. Cl. 711/137

(57) ABSTRACT

Methods and apparatuses for pushing data from a system agent to a cache memory.

### TECHNICAL FIELD

Embodiments of the invention relate to multi-processor computer systems. More particularly, embodiments of the invention relate to allowing external bus agents to push data to a cache corresponding to a processor in a multi-processor computer system.

### BACKGROUND

In current multi-processor systems, including Chip Multi-Processors, it is common for an input/output (I/O) device such as, for example, a network media access controller (MAC), a storage controller, a display controller, to generate temporary data to be processed by a processor core. Using traditional memory-based data transfer techniques, the temporary data is written to memory and subsequently read from memory by the processor core. Thus, two memory accesses are required for a single data transfer.

Because traditional memory-based data transfer techniques require multiple memory accesses for a single data transfer, these data transfers may be bottlenecks to system performance. The performance penalty can be further compounded by the fact that these memory accesses are typically off-chip, which results in further memory access latencies as well as additional power dissipation. Thus, current data transfer techniques result in system inefficiencies with respect to performance and power.

### BRIEF DESCRIPTION OF THE DRAWINGS

The invention is illustrated by way of example, and not by way of limitation, in the figures of the accompanying drawings in which like reference numerals refer to similar elements.

FIG. 1 is a block diagram of one embodiment of a computer system.

FIG. 2 is a conceptual illustration of a push operation from an external agent.

FIG. 3 is a conceptual illustration of a pipelined system bus architecture.

FIG. 4 is a flow diagram of one embodiment of a direct cache access for pushing data from an external agent to a cache of a target processor.

FIG. 5 is a control diagram of one embodiment of a direct cache access PUSH operation.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

Described herein are embodiments of an architecture that supports direct cache access (DCA, or “push cache”), which allows a device to coherently push data to an internal cache of a target processor. In one embodiment the architecture includes a pipelined system bus, a coherent cache architecture and a DCA protocol. The architecture provides increased data transfer efficiencies as compared to the memory transfer operations described above.

More specifically, the architecture may utilize a pipelining bus feature and internal bus queuing structure to effectively invalidate internal caches, and effectively allocate internal data structures that accept push data requests. One embodiment of the mechanism may allow devices connected to a processor to directly move data into a cache associated with the processor. In one embodiment a PUSH operation may be implemented with a streamlined handshaking procedure between a cache memory, a bus queue and/or an external (to the processor) bus agent.

The handshaking procedure may be implemented in hardware to provide high-performance direct cache access. In traditional data transfer operations an entire bus may be stalled for a write operation to move data from memory to a processor cache. Using the mechanism described herein, a non-processor bus agent may use a single write operation to move data to a processor cache without causing extra bus transactions and/or stalling the bus. This may decrease the latency associated with data transfer and may improve processor bus availability.

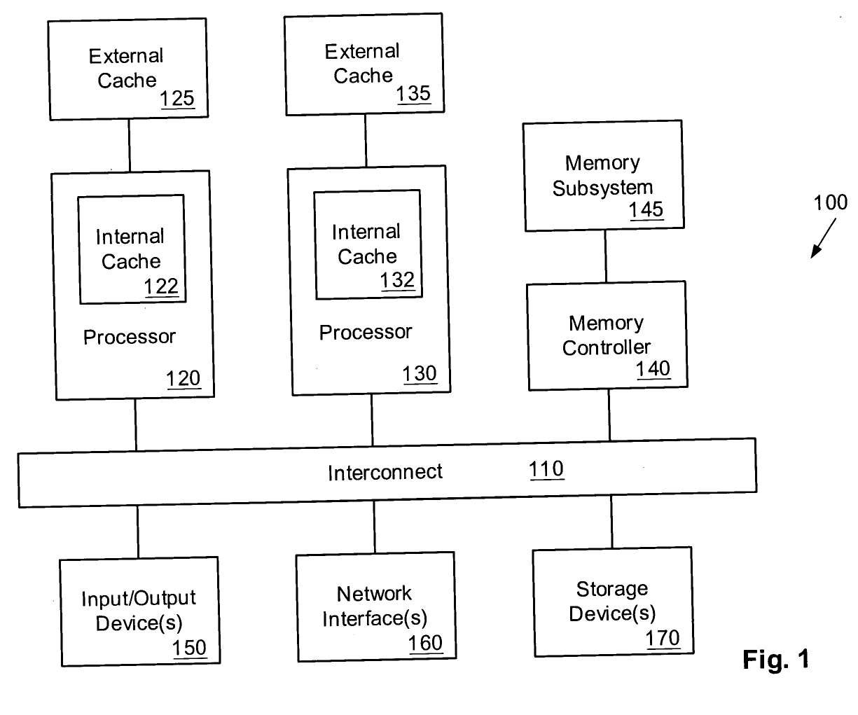

FIG. 1 is a block diagram of one embodiment of a computer system. The computer system illustrated in FIG. 1 is intended to represent a range of electronic systems including computer systems, network traffic processing systems, control systems, or any other multi-processor system. Alternative computer (or non-computer) systems can include more, fewer and/or different components. In the description of FIG. 1 the electronic system is referred to as a computer system; however, the architecture of the computer system as well as the techniques and mechanisms described herein are applicable to many types of multi-processor systems.

In one embodiment, computer system 100 may include interconnect 110 to communicate information between components. Processor 120 may be coupled to interconnect 110 to process information. Further, processor 120 may include internal cache 122, which may represent any number of internal cache memories. In one embodiment, processor 120 may be coupled with external cache 125. Computer system 100 may further include processor 130 that may be coupled to interconnect 110 to process information. Processor 130 may include internal cache 132, which may represent any number of internal cache memories. In one embodiment, processor 130 may be coupled with external cache 135.

While computer system 100 is illustrated with two processors, computer system 100 may include any number of processors and/or co-processors. Computer system 100 may also include random access memory controller 140 coupled with interconnect 110. Memory controller 140 may act as an interface between interconnect 110 and memory subsystem 145, which may include one or more types of memory. For example, memory subsystem 145 may include random access memory (RAM) or other dynamic storage device to store information and instructions to be executed by processor 120 and/or processor 130. Memory subsystem 145 also can be used to store temporary variables or other intermediate information during execution of instructions by processor 120 and/or processor 130. Memory subsystem may further include read only memory (ROM) and/or other static storage device to store static information and instructions for processors 120 and/or processor 130.

Interconnect 110 may also be coupled with input/output (I/O) devices 150, which may include, for example, a display device, such as a cathode ray tube (CRT) controller or liquid crystal display (LCD) controller, to display information to a user, an alphanumeric input device, such as a keyboard or touch screen to communicate information and command selections to processor 120, and/or a cursor control device, such as a mouse, a trackball, or cursor direction keys to communicate direction information and command selections to processor 102 and to control cursor movement on a display device. Various I/O devices are known in the art.

Computer system 100 may further include network interface(s) 160 to provide access to one or more networks, such as a local area network, via wired and/or wireless interfaces. A wired network interface may include, for example, a network interface card configured to communicate using an Ethernet or optical cable. A wireless network interface may include one or more antennae (e.g., a substantially omnidirectional antenna) to communicate according to one or more wireless communication protocols. Storage device 170 may be coupled to interconnect 110 to store information and instructions.

Instructions are provided to memory subsystem 145 from storage device 170, such as magnetic disk, a read-only memory (ROM) integrated circuit, CD-ROM, DVD, via a remote connection (e.g., over a network via network interface 160) that is either wired or wireless, etc. In alternative embodiments, hard-wired circuitry can be used in place of or in combination with software instructions. Thus, execution of sequences of instructions is not limited to any specific combination of hardware circuitry and software instructions.

An electronically accessible medium includes any mechanism that provides (i.e., stores and/or transmits) content (e.g., computer executable instructions) in a form readable by an electronic device (e.g., a computer, a personal digital assistant, a cellular telephone). For example, a machine-accessible medium includes read only memory (ROM); random access memory (RAM); magnetic disk storage media; optical storage media; flash memory devices; electrical, optical, acoustical or other form of propagated signals (e.g., carrier waves, infrared signals, digital signals); etc.

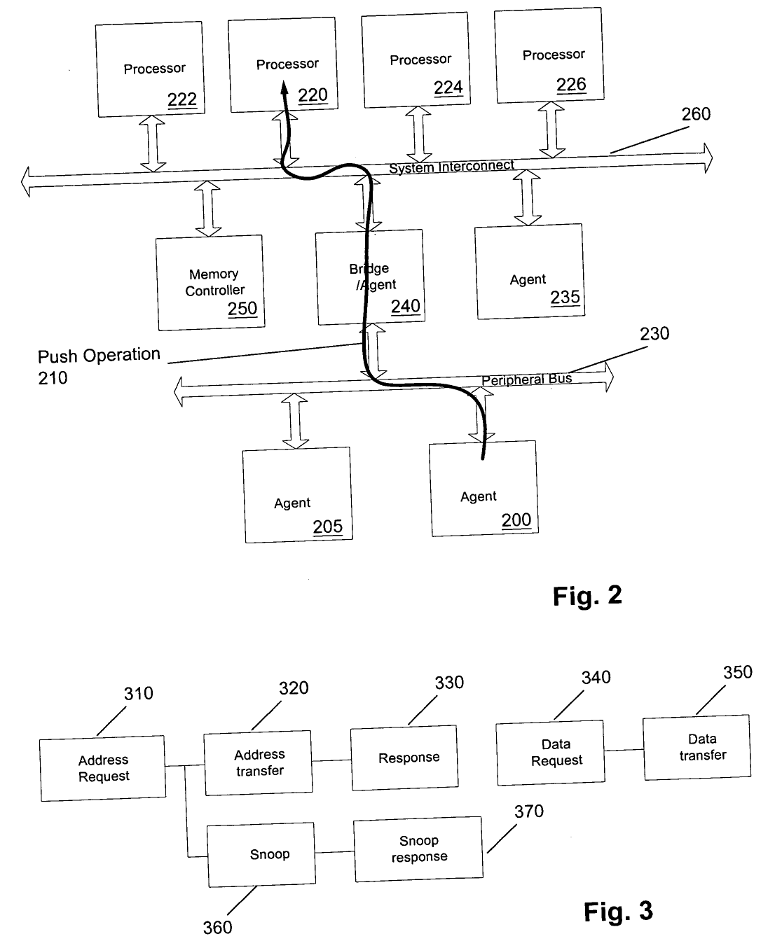

FIG. 2 is a conceptual illustration of a push operation from an external agent. The example of FIG. 2 corresponds to an external (to the target processor) agent that may push data a processor 220 in a multi-processor system 220, 222, 224, 226. The agent may be, for example, a direct memory access (DMA) device, a digital signal processor (DSP), a packet processor, or any other system component external to the target processor.

The data that is pushed by agent 200 may correspond to a full cache line or the data may correspond to a partial cache line. In one embodiment, during push operation 210, agent 200 may push data to an internal cache of processor 220. Thus, the data may be available for a cache hit on a subsequent load to the corresponding address by processor 220.

In the example of FIG. 2, push operation 210 is issued by agent 200 that is coupled to peripheral bus 230, which may also be coupled with other agents (e.g., agent 205). Push operation 210 may be passed from peripheral bus 230 to system interconnect 240 by bridge/agent 240. Agents may also be coupled with system interconnect 260 (e.g., agent 235). The target processor (processor 220) may receive push operation 210 from bridge/agent 240 over system interconnect 260. Any number of processors may be coupled with system interconnect 260. Memory controller 250 may also be coupled with system interconnect 260.

FIG. 3 is a conceptual illustration of a pipelined system bus architecture. In one embodiment, the bus is a free running non-stall bus. In one embodiment, the pipelined system bus includes separate address and data buses, both of which have one or more stages. In one embodiment, the address bus stages may operate using address request stage 310, address transfer stage 320 and address response stage 330. In one embodiment, one or more of the stages illustrated in FIG. 3 may be further broken down into multiple sub-stages.

In one embodiment, snoop agents may include snoop stage 360 and snoop response stage 370. The address stages and the snoop stages may or may not be aligned based on, for example, the details of the bus protocol being used. Snooping is known in the art and is not discussed in further detail herein. In one embodiment, the data bus may operate using data request stage 340 and data transfer stage 350.

In one embodiment the system may support a cache coherency protocol, for example, MSI, MESI, MOESI, etc. In one embodiment, the following cache line states may be used.

TABLE 1
Cache Line States for Target Processor

| | | State After | State |
|---|---|---|---|
| State Prior to | State After | Acknowledge | After Data |
| Address Request | Address Request | (ACK) Message | Return |
| M | Pending | ACK - M | M |
| O | Pending | ACK - Pending | M |
| E | Pending | ACK - Pending | M |
| S | Pending | ACK - Pending | M |
| I | Pending | ACK - Pending | M |
| Pending | Pending | ACK/Retry - | N/A |
| | | Pending | |
| M | Pending | Retry - M | M |
| O | Pending | Retry - O | M |
| E | Pending | Retry - I | M |
| S | Pending | Retry - I | M |
| I | Pending | Retry - I | M |

In one embodiment, PUSH requests and PUSH operations are performed at the cache line level; however, other granularities may be supported, for example, partial cache lines, bytes, multiple cache lines, etc. In one embodiment, initiation of a PUSH request may be identified by a write line operation with a PUSH attribute. The PUSH attribute may be, for example, a flag or a sequence of bits or other signal that indicates that the write line operation is intended to push data to a cache memory. If the PUSH operation is used to push data that does not conform to a cache line different operations may be used to initiate the PUSH request.

In one embodiment, the agent initiating the PUSH operation may provide a target agent identifier that may be embedded in an address request using, for example, lower address bits. The target agent identifier may also be provided in a different manner, for example, through a field in an instruction or by a dedicated signal path. In one embodiment, a bus interface of a target agent may include logic to determine whether the host agent is the target of a PUSH operation. The logic may include, for example, comparison circuitry to compare the lower address bits with an identifier of the host agent.

In one embodiment, the target agent may include one or more buffers to store an address and data corresponding to a PUSH request. The target agent may have one or more queues and/or control logic to schedule transfer of data from the buffers to the target agent cache memory. Various embodiments of the buffers, queues and control logic are described in greater detail below. Data may be pushed to a cache memory of a target agent by an external agent without processing by the core logic of the target agent. For example, a direct memory access (DMA) device or a digital signal processor (DSP) may use the PUSH operation to push data to a processor cache without requiring the processor core to coordinate the data transfer.

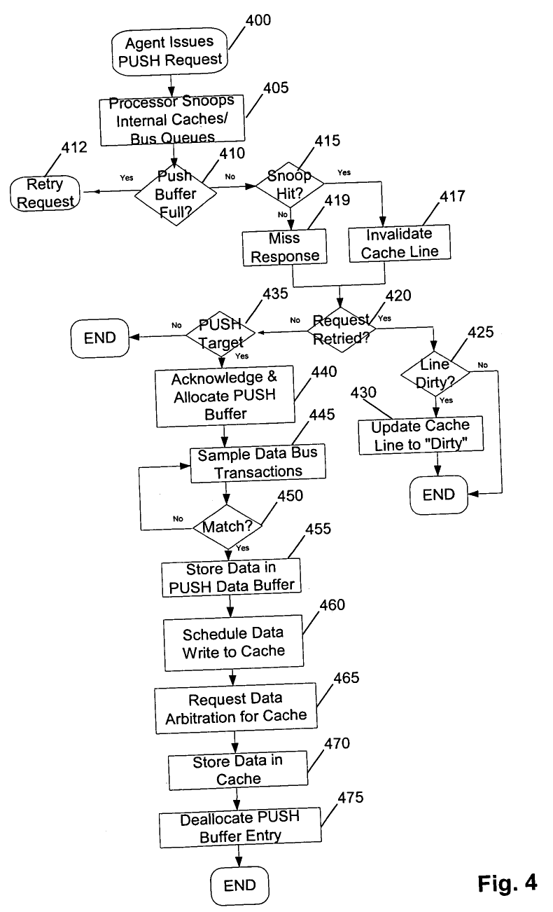

FIG. 4 is a flow diagram of one embodiment of a direct cache access for pushing data from an external agent to a cache of a target processor. The agent having data to be pushed to the target device issues a PUSH request, 400. The PUSH request may be indicated by a specific instruction (e.g., write line) that may have a predetermined bit or bit sequence. In one embodiment the PUSH request may be initiated as a cache line granular level. In one embodiment, the initiating agent may specify the target of the PUSH operation by specifying a target identifier during the address request stage of the PUSH operation.

In one embodiment a processor or other potential target agent may snoop internal caches and/or bus queues, 405. The snooping functionality may allow the processor to determine whether that processor is the target of a PUSH request. Various snooping techniques are known in the art. In one embodiment, the processor snoops the address bus to determine whether the lower address bits correspond to the processor.

In one embodiment, if the target processor push buffer is full, 410, a PUSH request may result in a retry request, 412. In one embodiment, if a request is not retried, the potential target agent may determine whether it is the target of the PUSH request, 415, which may be indicated by a snoop hit. A snoop hit may be determined by comparing an agent identifier with a target agent identifier that may be embedded in the PUSH request.

In one embodiment, if the target agent experiences a snoop hit, 415, the cache line corresponding to the cache line to be pushed is invalidated, 417. If the target agent experiences a snoop miss, 415, a predetermined miss response is performed, 419. The miss response can be any type of cache line miss response known in the art and may be dependent upon the cache coherency protocol being used.

After either the line invalidation, 417 or the miss response, 419, the target agent may determine whether the current PUSH request is retried, 420. If the PUSH request is retried, 420, the target agent determines whether the line was dirty, 425. If the line was dirty, 425, the cache line state may be updated to dirty, 430, to restore the cache line to its original state.

If the PUSH request is not retried, 420, the target agent may determine whether it is the target of the PUSH request, 435. If the target agent is the target of the PUSH request, 435, the target agent may acknowledge the PUSH request and allocate a slot in a PUSH buffer, 440. In one embodiment, the allocation of the PUSH buffer, 440 completes the address phase of the PUSH operation and subsequent functionality is part of a data phase of the PUSH operation. That is, in one embodiment, procedures performed through allocation of the PUSH buffer, 440, may be performed in association with the address bus using the address bus stages described above. Procedures performed subsequent to allocation of the PUSH buffer, 440, may be performed in association with the data bus using the data bus stages described above.

In one embodiment, the target agent may monitor data transactions for transaction identifiers, 445, that correspond to the PUSH request causing the allocation of the PUSH buffer, 440. When a match is identified, 450, the data may be stored in the PUSH buffer, 455.

In one embodiment, in response to the data being stored in the PUSH buffer, 455, bus control logic (or other control logic in the target agent) may schedule a data write to the cache of the target agent, 460. In one embodiment, the bus control logic may enter a write request corresponding to the data in a cache request queue. Other techniques for scheduling the data write operation may also be used.

In one embodiment, control logic in the target agent may request data arbitration for the cache memory, 465, to allow the data to be written to the cache. The data may be written to the cache, 470. In response to the data being written to the cache, the PUSH buffer entry corresponding to the data may be deallocated, 475. If the cache line was previously in a dirty state (e.g., M or 0), the cache line may be updated to its original state. If the cache line was previously in a clean state (e.g., E or S), the cache line may be left invalid.

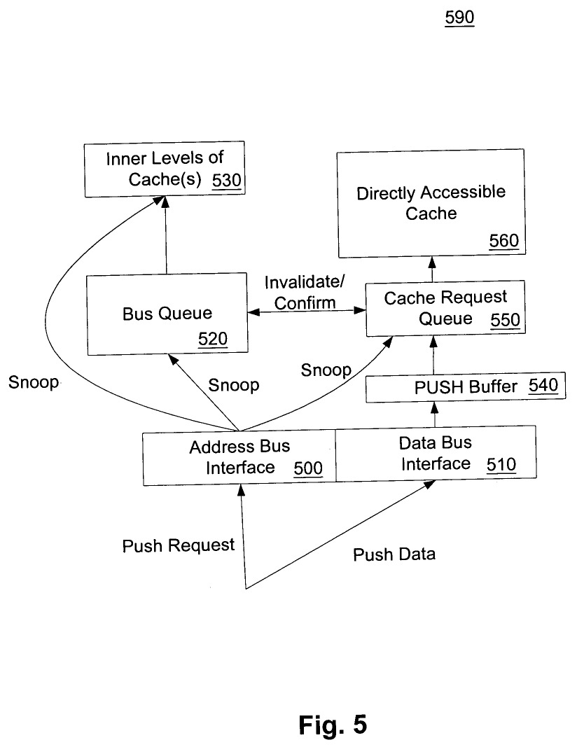

FIG. 5 is a control diagram of one embodiment of a direct cache access PUSH operation. In one embodiment, target agent 590 may include multiple levels of internal caches. FIG. 5 illustrates only one of many processor architectures including internal cache memories. In the example of FIG. 5, the directly accessible cache is an outer layer cache with ownership capability and the inner level cache(s) is/are write-through cache(s). In one embodiment a PUSH operation may invalidate all corresponding cache lines stored in the inner level cache(s). In one embodiment, the bus queue may be a data structure that tracks in-flight snoop requests and bus transactions.

In one embodiment, a PUSH request may be received by address bus interface 500 and data for the PUSH operation may be received by data bus interface 510. Data bus interface 510 may forward data from a PUSH operation to PUSH buffer 540. The data may be transferred from the PUSH buffer 540 to cache request queue 550 and then to directly accessible cache 560 as described above.

In one embodiment, in response to a PUSH request, address bus interface 500 may snoop transactions between various functional components. For example, address bus interface 500 may snoop entries to cache request queue 550, bus queue 520 and/or inner level cache(s) 530. In one embodiment, invalidation and/or confirmation messages may be passed between bus queue 520 and cache request queue 550.

In one embodiment, within a multi-processor system, each processor core may have an associated local cache memory structure. The processor core may access the associated local cache memory structure for code fetches and data reads and writes. The cache utilization may be affected by program cacheability and the cache hit rate of the program that is being executed.

For a processor core that supports the PUSH operation, the external bus agent may initiate a cache write operation from outside of the processor. Both the processor core and the external bus agent may compete for cache bandwidth. In one embodiment, a horizontal processing model may be used in which multiple processors may perform equivalent tasks and data may be pushed to any processor. Allocation of traffic associated with PUSH operations may improve performance by avoiding unnecessary PUSH request retires.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
receiving a request to push data to a cache memory associated with a processor in a multi-processor system, wherein the data is to be pushed to the cache memory without a corresponding read request form the processor;
storing the data in a push buffer in the processor; and
transferring the data from the push buffer to the cache memory.

2. The method of claim 1 further comprising:
snooping a cache request queue to determine whether a number of push buffer entries equals or exceeds a threshold level;
generating a retry request corresponding to the request to push data if the number of push buffer entries equals or exceeds the threshold level; and
determining whether data corresponding to the request to push data is stored in the cache memory if the number of push buffer entries does not equal or exceed the threshold level.

3. The method of claim 2 further comprising:
determining whether the request to push data is a retried request to push data; and
restoring a state of data corresponding to the request to push data if the request is retried.

4. The method of claim 1 further comprising:
analyzing the push to request data to determine whether a device receiving the request is a target for the request;
generating an acknowledgement if the device receiving the request is the target for the request; and
allocating an entry in a push buffer for the data to be pushed if the device receiving the request is the target for the request.

5. The method of claim 4 further comprising snooping data bus transactions to identify data being pushed in response to the acknowledgement.

6. The method of claim 5 further comprising storing the data being pushed in the allocated entry of the push buffer.

7. The method of claim 1 wherein transferring the data form the push buffer to the cache memory comprises:
scheduling a write operation to cause the data to be written to an entry in the cache memory;
requesting data arbitration for the entry in the cache memory;
storing the data in the entry in cache memory; and
deallocating the data from the push buffer.

8. The method of claim 7 wherein the entry in the cache memory comprises a complete cache line.

9. The method of claim 7 wherein the entry in the cache memory comprises a partial cache line.

10. The method of claim 1 wherein the request to push data is received from a direct memory access (DMA) device.

11. The method of claim 1 wherein the request to push data is received from a digital signal processor (DSP).

12. The method of claim 1 wherein the request to push data is received from a packet processor.

13. An apparatus comprising:
a cache memory;
an address bus interface to receive a push request from an address bus;
a data bus interface to receive data to be pushed to a cache memory from a data bus;
a bus queue coupled with the address bus interface to store push requests received from the address bus;
a push buffer coupled with the data bus interface to store data to be pushed to the cache memory;
a cache request queue coupled with the push buffer, the bus queue and the cache memory to schedule a cache write operation to cause the data to be written to the cache memory.

14. The apparatus of claim 13 further comprising one or more inner level caches coupled with the bus queue that do not receive the data from the cache request queue.

15. The apparatus of claim 14 wherein the address bus interface snoops transactions involving the cache request queue.

16. The apparatus of claim 14 wherein the address bus interface snoops transactions involving the bus queue.

17. The apparatus of claim 14 wherein the address bus interface snoops transactions involving the inner level caches.

18. The apparatus of claim 13 wherein the cache request queue operates to schedule a write operation to cause the data to be written to an entry in the cache memory, request data arbitration for the entry in the cache memory, store the data in the entry in cache memory, and deallocate the data from the push buffer.

19. The apparatus of claim 13 wherein the address bus interface operates to analyze the push request to determine whether the address bus interface corresponds to a target for the request and generate an acknowledgement if the device receiving the request is the target for the request.

20. A system comprising:
a cache memory;
an address bus interface to receive a push request from an address bus;
a data bus interface to receive data to be pushed to a cache memory from a data bus;
a bus queue coupled with the address bus interface to store push requests received from the address bus;
a push buffer coupled with the data bus interface to store data to be pushed to the cache memory;
a cache request queue coupled with the push buffer, the bus queue and the cache memory to schedule a cache write operation to cause the data to be written to the cache memory; and
one or more substantially omnidirectional antennae coupled with the data bus.

21. The system of claim 20 further comprising one or more inner level caches coupled with the bus queue that do not receive the data from the cache request queue.

22. The system of claim 21 wherein the address bus interface snoops transactions involving the cache request queue.

23. The system of claim 21 wherein the address bus interface snoops transactions involving the bus queue.

24. The system of claim 21 wherein the address bus interface snoops transactions involving the inner level caches.

25. The system of claim 20 wherein the cache request queue operates to schedule a write operation to cause the data to be written to an entry in the cache memory, request data arbitration for the entry in the cache memory, store the data in the entry in cache memory, and deallocate the data from the push buffer.

26. The system of claim 20 wherein the address bus interface operates to analyze the push request to determine whether the address bus interface corresponds to a target for the request and generate an acknowledgement if the device receiving the request is the target for the request.

27. An apparatus comprising:
a cache memory;
an address bus interface to receive a push request from an address bus;
a data bus interface to receive data to be pushed to a cache memory from a data bus;
a bus queue coupled with the address bus interface to store push requests received from the address bus, wherein the address bus interface snoops transactions involving the bus queue;
a push buffer coupled with the data bus interface to store data to be pushed to the cache memory;
a cache request queue coupled with the push buffer, the bus queue and the cache memory to schedule a cache write operation to cause the data to be written to the cache memory, wherein the address bus interface snoops transactions involving the cache request queue; and
one or more inner level caches coupled with the bus queue that do not receive the data from the cache request queue, wherein the address bus interface snoops transactions involving the inner level caches.

28. The apparatus of claim 27 wherein the cache request queue operates to schedule a write operation to cause the data to be written to an entry in the cache memory, request data arbitration for the entry in the cache memory, store the data in the entry in cache memory, and deallocate the data from the push buffer.

29. The apparatus of claim 27 wherein the address bus interface operates to analyze the push request to determine whether the address bus interface corresponds to a target for the request and generate an acknowledgement if the device receiving the request is the target for the request.
